(19) United States
(12) Patent Application Publication
(10) Pub. No.: US 2003/0091283 A1
(43) Pub. Date: May 15, 2003

(54) Tunable chromatic compensator

(76) Inventors: Sean Chang, Tao Yuan City (TW); Sean Huang, Chang Hua (TW)

Correspondence Address: MARTINE & PENILLA, LLP, 710 LAKEWAY DRIVE, SUITE 170, SUNNYVALE, CA, 94085, US

(21) Appl. No.: 10/126,180

(22) Filed: Apr. 19, 2002

(30) Foreign Application Priority Data
Nov. 12, 2001 (TW) 90128036

(51) Int. Cl. G02B 6/34

(52) U.S. Cl. 385/37

(57) ABSTRACT

To compensate chromatic dispersions of the optical signals travelling through different distances and/or having different wavelengths, a tunable chromatic compensator includes a waveguide element and a plurality of gratings provided in the waveguide element. The gratings have different central wavelengths and the proportion of the magnitude of the spectral range (reflected by each grating) to the difference value of the time delay differs from each other. When the waveguide element receives an optical pulse signal, the central wavelengths of the plurality of gratings change with the change of the length of the waveguide element. The optical pulse signal can selectively travel through one of the plurality of gratings by changing the length of the waveguide element. Thus, different difference values of the time delays can be selectively obtained to compensate the chromatic dispersion.

### BACKGROUND OF THE INVENTION

1. Field of the Invention

The invention relates to a chromatic compensator, in particular, to a tunable chromatic compensator capable of compensating of chromatic dispersion in various degrees.

2. Related Art

The same medium possesses different refractive indexes with respect to light having different wavelengths. Since the refractive indexes of light are associated with the traveling speed of light, the transmission speeds of the optical signals having different wavelengths are not the same when the light travels in a medium. When the optical signals travel a longer distance in a medium such as an optical fiber, the speed differences cause the chromatic dispersion of the optical signals and thus cause bad results.

Taking an optical pulse signal as an example, the optical pulse signal includes spectral components within a predetermined region. When the optical pulse signal travels through the optical fiber, different spectral components arrive at the same point at different times due to the above-mentioned chromatic dispersion effect. Therefore, if the transmitting end sends a series of pulse signals over a short period of time, the receiving end may tend to misjudge or misread the pulse signals.

In order to solve the above-mentioned problem of the chromatic dispersion, a conventional technology using fiber gratings to compensate the chromatic dispersion after optical signals having different wavelengths travel a long distance. Referring to FIG. 1, the fiber grating 21 in the optical fiber 2 has the property of reflecting light having different wavelengths at different locations. That is, optical path differences are generated after the fiber grating 21 reflects the light having different wavelengths. Therefore, if the wavelengths of the input light and the distance traveled by the light in the medium are known in advance, the fiber grating 21 can be used to compensate the chromatic dispersion generated after the optical signals travel a long distance.

However, the chromatic compensator can only compensate the chromatic dispersion with respect to specific wavelengths and chromatic dispersion values. Under the condition of different transmission distances and different wavelengths, the optical pulse signals cannot be compensated in the same chromatic compensator.

### SUMMARY OF THE INVENTION

In view of the above-mentioned problems, it is an object of the invention to provide a tunable chromatic compensator capable of compensating the chromatic dispersion caused by the different transmission distances and/or by different wavelengths.

To achieve the above-mentioned object, the invention provides a tunable chromatic compensator including a waveguide element and a plurality of gratings. The plurality of gratings are provided in the waveguide element. The plurality of gratings have different central wavelengths. The proportion of the magnitude of the spectral range reflected by each grating to the difference value of the time delay differs from each other. When the waveguide element receives an optical pulse signal, the central wavelengths of the gratings change with the change of the length of the waveguide element so that the optical pulse signal can be optionally transmitted through one of the gratings by changing the length of the waveguide element.

In one aspect of the invention, the gratings in the waveguide element are arranged such that the traveling distance of the optical pulse signal with a longer wavelength is greater than that of the optical pulse signal with a shorter wavelength.

In another aspect of the invention, the waveguide element is an optical fiber which can be stretched so as to change its length.

In the tunable chromatic compensator provided by the invention, the optical pulse signal which travels a long distance through the optical fiber, can selectively pass through different gratings. Thus, different difference values of the time delays can be selectively obtained to compensate the chromatic dispersion.

### BRIEF DESCRIPTION OF THE DRAWINGS

FIG. 1 is a schematic illustration showing a conventional compensating the chromatic dispersion by a fiber grating.

FIG. 2 is a schematic illustration showing a structure of a tunable chromatic compensator in accordance with a preferred embodiment of the invention.

FIG. 3 is a graph showing the relationship between the reflective spectrum and the time delay of each grating in the tunable chromatic compensator in accordance with the preferred embodiment of the invention.

FIG. 4 is a schematic illustration showing that the tunable chromatic compensator in accordance with the preferred embodiment of the invention is stretched.

FIG. 5 is a graph showing the relationship between the reflective spectrum and the time delay of each grating before and after the tunable chromatic compensator in accordance with the preferred embodiment of the invention is stretched.

FIG. 6 is a schematic illustration showing a structure of the tunable chromatic compensator in accordance with another preferred embodiment of the invention.

FIG. 7 is a graph showing the relationship between the reflective spectrum and the time delay of each grating before and after the tunable chromatic compensator in accordance with another preferred embodiment of the invention is stretched.

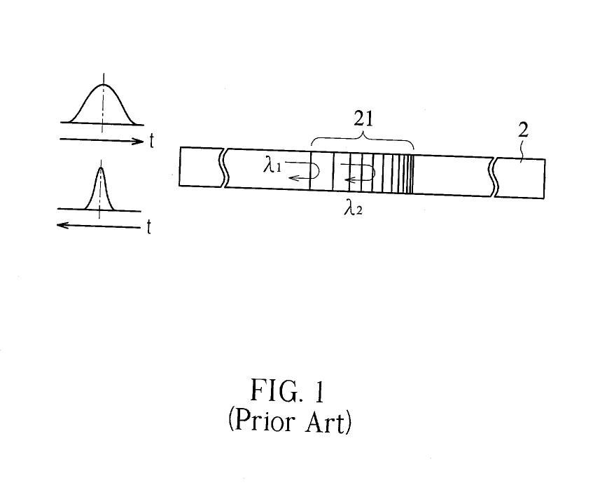

### DETAILED DESCRIPTION OF THE PREFERRED EMBODIMENTS

The tunable chromatic compensator in accordance with the preferred embodiments of the invention will be described with reference to the accompanying drawings, wherein the same reference numbers denote the same elements.

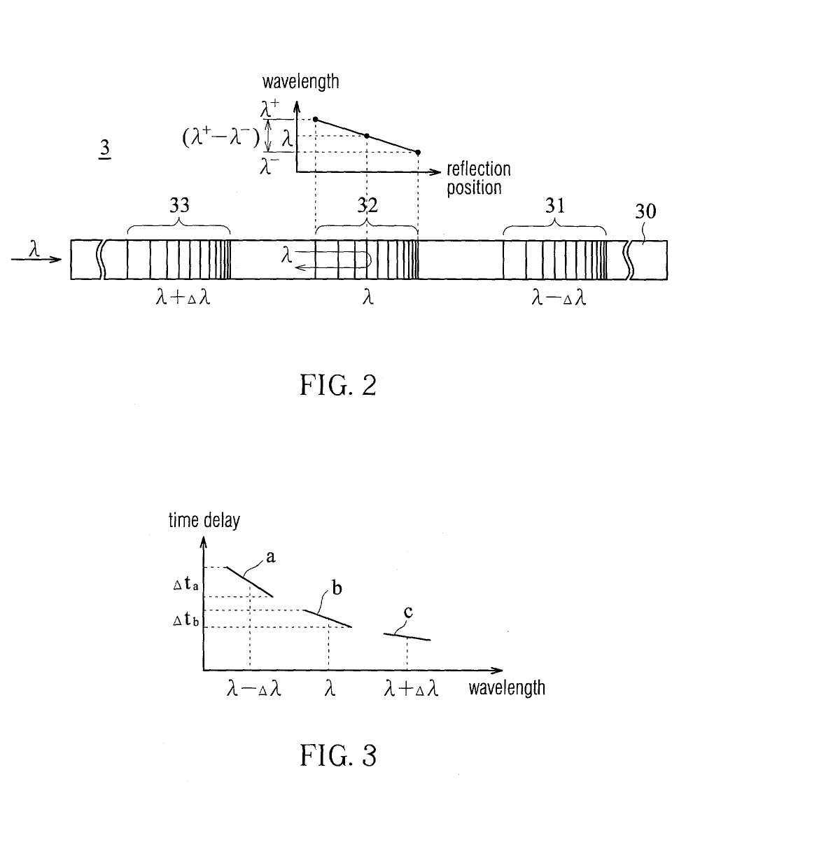

Referring to FIG. 2, a tunable chromatic compensator 3 in accordance with a preferred embodiment of the invention is provided with a plurality of fiber Bragg gratings (FBGs) 31, 32 and 33 in an optical fiber 30. The central wavelengths of fiber gratings 31, 32 and 33 are λ−Δλ, λ and λ+Δλ, respectively.

Since each fiber grating is composed of many Bragg reflection regions having different Bragg wavelengths, the spectral components having different wavelengths in the optical pulse signal can be reflected at different positions of a fiber grating. Referring to FIG. 2 and taking the fiber grating 32 as an example, the central wavelength of the fiber grating 32 is λ. The fiber grating 32 can reflect, at different positions x, different spectral components having different wavelengths. In the fiber grating 32, since the spectral component having a longer wavelength is reflected earlier, which travels a shorter distance. The spectral range that can be reflected by the fiber grating 32 ranges from λ⁺ to λ⁻, and the value of the spectral range is (λ⁺−λ⁻).

In the optical fiber 30, the transmission speed of the optical signal having a shorter wavelength is faster than that of the optical signal having a longer wavelength. Therefore, as described above, the fiber gratings 31, 32 and 33 reflect the spectral component having a shorter wavelength later so as to obtain a longer time delay, and reflect the spectral component having a longer wavelength earlier so as to obtain a shorter time delay. Accordingly, when a pulse signal travels to the tunable chromatic compensator 3, it can be reflected at the fiber grating 31, 32 or 33. Different time delays are given with respect to different spectral components to compensate the chromatic dispersion generated due to the long transmission distance of the pulse signal.

FIG. 3 shows the relationship between the fiber gratings having different central wavelengths and time delays. A line segment “a” represents the relationship between the wavelength spectrum of the fiber grating 31 and the time delay. A line segment “b” represents the relationship between the wavelength spectrum of the fiber grating 32 and the time delay. A line segment “c” represents the relationship between the wavelength spectrum of the fiber grating 33 and the time delay. As shown in FIG. 3, the absolute value of the slope of the line segment “a” is greater, which means that the fiber grating 31 can provide a greater difference value tₐ of the time delay in a certain spectral range. Therefore, the fiber grating 31 can be used to compensate a greater chromatic dispersion value. Compared to the line segment “a”, the slope of the line segment “b” is smaller, which means that a difference value t_{b} of the time delay provided by the fiber grating 32 is smaller than tₐ in a certain spectral range.

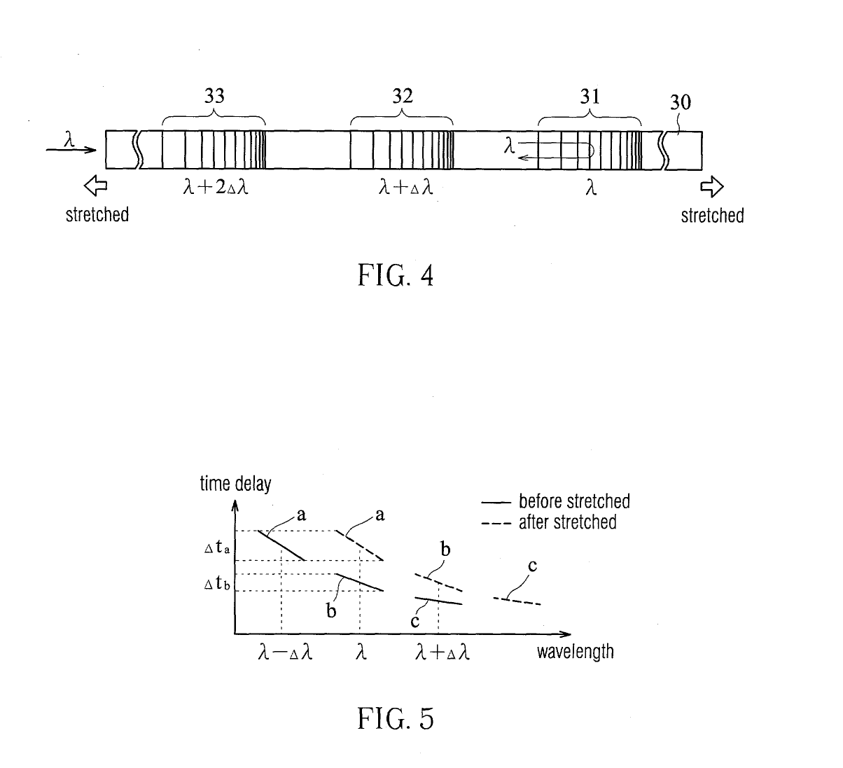

Each of the fiber gratings 31, 32 and 33 is composed of Bragg reflection regions. The Bragg wavelength of the fiber grating changes with the change in the length of the fiber grating. In other words, when the optical fiber 30 is stretched, the central wavelength that can be reflected by each fiber grating in the optical fiber 30 increases. When the optical fiber 30 is compressed and shortened, the central wavelength that can be reflected by each fiber grating in the optical fiber 30 decreases. Referring to FIG. 4, for example, when the optical fiber 30 is stretched to a predetermined extent, the central wavelength of the fiber grating 31 increases from λ−≢λ to λ. Similarly, the central wavelength of the fiber grating 32 increases from λ to λ+Δλ, while the central wavelength of the fiber grating 33 increases from λ+Δλ to λ+2Δλ.

At this time, instead of the fiber grating 32, the fiber grating 31 becomes the one having the central wavelength of λ. Therefore, the pulse signal having the wavelength of λ is reflected at the fiber grating 31. The chromatic dispersion value of the pulse signal is also compensated by the fiber grating 31.

Referring to FIG. 5, when the optical fiber 30 is stretched, the relationship between the fiber grating and the time delay shifts from the solid lines to the dashed lines. Since the chromatic dispersion value of the pulse signal is compensated by the fiber grating 31, the difference value of the time delay that can be obtained with respect to the pulse signal having the wavelength of λ changes from t_{b} to tₐ greater than t_{b}.

According to the design of this embodiment, since the magnitude of the chromatic dispersion value is positively associated with the transmitting distance of the optical signal, the tunable chromatic compensator 3 can adjust the chromatic dispersion compensation of the optical signal after the optical signal has traveled different distances by changing the length of the optical fiber 30. For example, if the fiber gratings 31, 32 and 33 can compensate the chromatic dispersion after the pulse signal has traveled 3L, 2L and 1L kilometers, respectively, the tunable chromatic compensator 3 is capable of selectively compensating the chromatic dispersion after the pulse signal has traveled 1L, 2L or 3L kilometers by adjusting the length of the optical fiber 30.

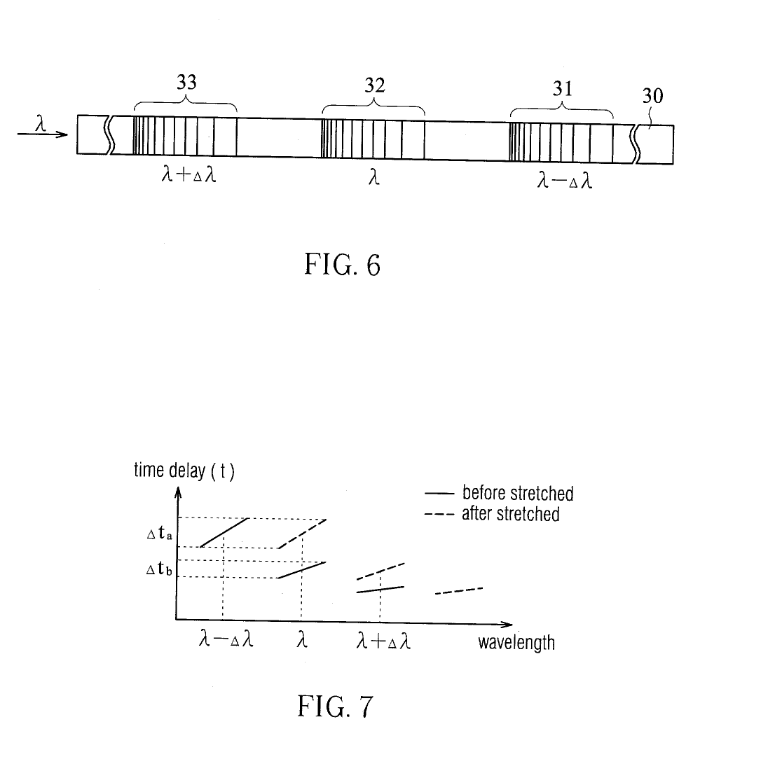

It should be noted that those skilled in the art might easily make arbitrary alterations or modifications without departing from the spirit and scope of the invention. For example, if the transmission speed of the optical signal having a longer wavelength in the optical fiber is faster than that of the optical signal having a shorter wavelength, the fiber gratings 31, 32 and 33 can be arranged reversibly, as shown in FIG. 6, so that the signal having a longer wavelength travels a longer distance in each fiber grating. Thus, the time delay for the signal having a longer wavelength is greater than that for the signal having a shorter wavelength.

As shown in FIG. 7, according to the above-mentioned modification, when the optical fiber 30 is stretched, the relationship between the central wavelength and the time delay of each fiber grating changes from the solid lines to the dashed lines. After the optical fiber 30 is stretched, the difference value of the time delay that can be obtained from the pulse signal having the wavelength of λ changes from t_{b} to tₐ greater than t_{b}. Thus, the tunable chromatic compensator 3 can adjust the chromatic dispersion compensation of the optical signal after the optical signal has traveled different distances by changing the length of the optical fiber 30.

While the invention has been described by way of examples and in terms of preferred embodiments, it is to be understood that the invention is not limited to the disclosed embodiments. To the contrary, it is intended to cover various modifications. Therefore, the scope of the appended claims should be accorded the broadest interpretation so as to encompass all such modifications.

What is claimed is:

1. A tunable chromatic compensator comprising:
a waveguide element receiving an optical pulse signal; and
a plurality of gratings provided in the waveguide element and having different central wavelengths, wherein the proportions of the magnitudes of the spectral ranges to the time delays of the gratings are different,
wherein the central wavelengths of the plurality of gratings change with the change of a length of the waveguide element, and the optical pulse signal can selectively travel through one of the plurality of gratings by changing the length of the waveguide element.

2. The tunable chromatic compensator according to claim 1, wherein the plurality of gratings in the waveguide element are arranged such that a distance traveled by a spectral component having a longer wavelength in the optical pulse signal is greater than that traveled by another spectral component having a shorter wavelength.

3. The tunable chromatic compensator according to claim 1, wherein the plurality of gratings in the waveguide element are arranged such that a distance traveled by a spectral component having a longer wavelength in the optical pulse signal is smaller than that traveled by another spectral component having a shorter wavelength.

4. The tunable chromatic compensator according to claim 1, wherein the length of the waveguide element is changed by stretch.

5. The tunable chromatic compensator according to claim 1, wherein the length of the waveguide element is changed by compression.

6. The tunable chromatic compensator according to claim 1, wherein the waveguide element is an optical fiber.

7. The tunable chromatic compensator according to claim 6, wherein the plurality of gratings are fiber Bragg gratings.

8. A tunable chromatic compensator comprising:
a waveguide element provided with a plurality of Bragg reflection regions having different Bragg wavelengths for reflecting optical signals having different wavelengths, wherein the length of the waveguide element can be changed so that a distance difference traveled by the optical signals reflected in the waveguide element can be adjusted.

9. The tunable chromatic compensator according to claim 8, wherein the Bragg reflection regions are a plurality of gratings.

10. The tunable chromatic compensator according to claim 8, wherein the waveguide element is an optical fiber.

11. The tunable chromatic compensator according to claim 8, wherein the Bragg reflection regions in the waveguide element are arranged such that a distance traveled by an optical signal having a longer wavelength in the optical signals is greater than that traveled by another optical signal having a shorter wavelength in the optical signals.

12. The tunable chromatic compensator according to claim 8, wherein the Bragg reflection regions in the waveguide element are arranged such that a distance traveled by an optical signal having a shorter wavelength in the optical signals is greater than that traveled by another optical signal having a longer wavelength in the optical signals.

13. The tunable chromatic compensator according to claim 8, wherein the waveguide element is stretched to change a difference value in the distance traveled by the reflected optical signals.

14. The tunable chromatic compensator according to claim 8, wherein the waveguide element is compressed to change a difference value in the distance traveled by the reflected optical signals.

15. The tunable chromatic compensator according to claim 8, wherein the optical signals are optical pulse signals.
